(19) United States
(12) Patent Application Publication
(10) Pub. No.: US 2017/0319009 A1
(43) Pub. Date: Nov. 9, 2017

(54) Herb Grinder

(71) Applicants: Brian Seckel, Boulder, CO (US); Jesse Gruber, Boulder, CO (US)

(72) Inventors: Brian Seckel, Boulder, CO (US); Jesse Gruber, Boulder, CO (US)

(21) Appl. No.: 15/491,385

(22) Filed: Apr. 19, 2017

Related U.S. Application Data
(60) Provisional application No. 62/333,180, filed on May 7, 2016.

(51) Int. Cl. A47J 42/34; B02C 18/22; B02C 18/08

(52) U.S. Cl. CPC A47J 42/34; B02C 18/08; B02C 18/2216

(57) ABSTRACT

The invention relates to devices and methods for grinding, storing, and dispensing plant materials such as herbs, flowers, plants, seeds, and leaves, including legal cannabis, coffee, tea, and tobacco, and methods of manufacturing such devices. A modular grinder that can be assembled into multiple configurations and grinds, stores, and dispenses ground plant material is provided. Methods of grinding, storing, and dispensing plant material that employ the modular grinder are provided.

### CROSS-REFERENCE TO RELATED APPLICATIONS

This application claims the benefit of U.S. Provisional Patent Application Ser. No. 62/333,180 filed on May 7, 2016 and entitled “HERB GRINDER”, the contents of which is hereby incorporated by reference in its entirety.

### FIELD OF THE INVENTION

The present invention generally relates to methods and apparatus for grinding, storing, transporting, and dispensing herbs, spices, flowers, plants, seeds, and leaves, including cannabis, coffee, tea, and tobacco.

### BACKGROUND OF THE INVENTION

An herb grinder is a cylindrical device with two halves (top and bottom) that separate and have sharp teeth or pegs aligned in such a way that when both halves are turned, the material inside is shredded. Herb grinders are used for crushing dried herbs and spices into particles. Grinding the herb into particles allows for the herb to be smoked, cooked or otherwise used.

Though ostensibly intended for use with herbs and spices for cooking, herb grinders are more commonly used to shred tobacco and cannabis, also known as marijuana, resulting in a product that can be more easily hand-rolled into a joint that burns more evenly. Herb grinders are typically made of either metal or plastic and come in a variety of colors and polished metals. Some grinders have two or three compartments instead of just one, with fine screens separating the bottom compartments from the ones above, thus allowing the marijuana trichomes, also called kief, or pollen, to be collected separately.

Herb grinders can be turned either manually or electronically. Electronic grinders are typically driven by a motor, which can generate heat and potentially damage the herb. Electronic grinders are also expensive. For grinding a small quantity of herbs, a manual grinder can achieve a similar result compared to an electric grinder with minimal effort and at a lower cost.

Herb grinders in their current form do not have a convenient way to dispense the herbs contained inside. In addition, current forms of herb grinders are not produced in a shape made for portability and are often bulky and cumbersome. Current herb grinders usually work in only one, or in limited configurations.

Other problems arise in connection with herb grinders that employ pegs in a non-locking manner, which can break open when dropped and spill the contents. Also, most herb grinders require two hands to dispense, which is inconvenient for the user. Other issues include inefficient grind patterns that consistently leave herbs wedged in the center upon completing the grinding process. Furthermore, standard designs are not airtight. The lack of protection from air and liquids cause the herbs to spoil faster. Water contamination poses one of the most serious threats in that it can instantly ruin a stored load of herbs.

Additional problems arise from the limited vertical loading capacity. Most grinders can only be loaded up to the top rim of the grinder, which is typically at the top of the grind teeth. These grinders are often nonportable and uncomfortable to fit in a pocket for transport. In addition, traditional grinders are often inconvenient because they have limited storage capacity.

Thus, a need exists for methods and apparatus for grinding, storing, transporting, and dispensing herbs, spices, flowers, plants, seeds, and leaves, including cannabis, coffee, tea, and tobacco in a more efficient way.

### SUMMARY OF THE INVENTION

An embodiment of the invention provides a grinder to grind, store and dispense plant materials, the plant materials comprising dried herbs, spices, flowers, seeds, and leaves;

wherein the grinder is configured for manual modular assembly of parts that are configured to reversibly connect into multiple configurations that include a grinding configuration and a storage configuration;

wherein the parts comprise a top piece, multiple middle sections, and a bottom point;

wherein the top piece, each middle section, and the bottom point are configured to connect to one or more other section with reversible connections that allow for assembly into the multiple configurations;

wherein the top piece is configured to reversibly connect to one or more middle section, and one or more middle section is configured to connect to the bottom point;

wherein the middle sections comprise a set of grind teeth that separates into top and bottom grind teeth, a grinder reservoir, a storage reservoir, and a dispense mechanism;

wherein the grinding configuration comprises a set of grind teeth, and the storage configuration excludes one or more section having grind teeth, and the excluded one or more section comprises a section with top grind teeth, and a section with bottom grind teeth; and

wherein the top piece is configured to close an opening at the top of the grinder when reversibly connected to the top of one or more of grinder reservoir and storage reservoir in the storage configuration.

Another embodiment provides the grinder as described herein-above wherein the set of grinding teeth comprises a top grind cylinder with teeth at or near its bottom end, and a bottom grind plate;

wherein the top piece is configured to provide a handgrip for manual grinding when reversibly connected to the top of the top grind cylinder in the grinding configuration,

wherein the top grind cylinder is configured to reversibly connect to the bottom of the top piece with its top connection to provide an insert piece;

wherein the insert piece is configured to insert into and reversibly connect to the grinder reservoir with a connection configured to allow it to spin and grind plant material;

wherein the grinder reservoir is configured to reversibly connect to the top piece, to the top grind cylinder, to connect to the bottom grind plate, and optionally to connect the top of the storage reservoir;

wherein the bottom grind plate is configured to connect to the bottom of the grinder reservoir and the top of the storage reservoir, and is configured to allow ground plant material of a desired particle size to fall through from the grinder reservoir to the storage reservoir;

wherein the storage reservoir is configured to connect to one or more of the bottom of the grinder reservoir and the bottom of the bottom grind plate, and to connect to one or more of the top of the bottom point, the top of the optional dedicated dispense tube, and the top of one or more optional attachments;

wherein the dispense mechanism is housed within the storage reservoir, or in an optional dedicated dispenser tube, and is configured to move the ground plant material to the bottom point or to a bottom attachment when the dispense mechanism is activated; and

wherein the bottom point or bottom attachment is configured to reversibly connect with its top connection to the bottom of the storage reservoir or to the bottom of the optional dedicated dispenser tube, and wherein the bottom point or bottom attachment is configured to allow ground plant material to exit from the bottom of the grinder when the dispense mechanism is activated.

Another embodiment provides a grinder as described herein-above wherein wherein each of the multiple parts that reversibly connect to one or more other part is configured with one or more connection, and the one or more connection is configured by one or more of the group consisting of: threads that are configured to mate, magnets that that are configured to connect, a magnet attached to a part of the herb grinder that is configured to connect to another metal part, magnetic material of a part that is configured to connect to one or more of another metal part, another magnet of another part, and another magnetic part.

Another embodiment provides a grinder as described herein-above wherein the top piece is configured to reversibly connect through threads to both the top grind cylinder and to the grinder reservoir;

wherein the grinder reservoir is configured to connect to the top piece, and is configured to connect to one or more of the bottom grind plate and the storage reservoir, either simultaneously or alternatively;

wherein the storage reservoir is configured to connect to one or more of the grinder reservoir and the bottom grind plate, either simultaneously or alternatively; and

wherein the storage reservoir has a top connection and a bottom connection, and at its top connection is configured to connect to one or more of the grinder reservoir and the bottom grind plate, and at its bottom connection connects to the bottom point.

Another embodiment provides a grinder as described herein-above wherein the top piece and the top grind cylinder are configured to be inserted and screwed into the grinder reservoir through their thread connections, and wherein the top piece comprise a non-threaded section that allows the top piece and top grind cylinder to spin freely inside the grinder reservoir when their threads are fully mated to the threads of the grinder reservoir.

Another embodiment provides a grinder as described herein-above, wherein the top piece magnetic and connects to both the top grind cylinder and to the grinder reservoir; wherein the top grind cylinder and the grinder reservoir are metal sections, or are adapted with magnets configured to connect to the top piece; wherein the grinder reservoir is configured to connect to the top piece magnetically, and is configured to connect to one or more of the bottom grind plate and the storage reservoir, either simultaneously or alternatively; wherein the storage reservoir is configured to connect to one or more of the grinder reservoir and the bottom grind plate, either simultaneously or alternatively; and wherein the storage reservoir has a top connection and a bottom connection, and at its top connection is configured to connect to one or more of the grinder reservoir and the bottom grind plate, and at its bottom connection connects to the bottom point.

Another embodiment provides a grinder as described herein-above wherein one or more of its parts and sections are configured to provide an enclosed environment including an airtight environment, a watertight environment, and an airtight and watertight environment.

Another embodiment provides a grinder as described herein-above, wherein one or more of its parts and sections are configured to provide a sealed environment upon assembly, with one or more O-rings placed where sections connect.

Another embodiment provides a grinder as described herein-above, wherein the teeth of the top grind cylinder comprise intersecting, circular diamond grind teeth.

Another embodiment provides a grinder as described herein-above, wherein and the teeth of the top grind cylinder and the bottom grind plate form an intersecting set configured to allow grinding.

Another embodiment provides a grinder as described herein-above, wherein the teeth of the top grind cylinder or the bottom grind plate comprise one or more sets of teeth having a shape selected from circular, cylindrical, oval, rectangular, and trapezoidal teeth, or a combination thereof.

Another embodiment provides a grinder as described herein-above, wherein the teeth of one or more of top grind cylinder and bottom grind plate comprise a teeth configuration selected from pyramidal, square, circular, oval, curved, pointy, flat, convex, concave, or any combination thereof.

Another embodiment provides a grinder as described herein-above, wherein one or more of the sections are adapted from round bar stock by subtractive manufacturing.

Another embodiment provides a grinder as described herein-above, wherein the storage reservoir comprises more one or more enclosed compartment to store the ground plant material.

Another embodiment provides a grinder as described herein-above, wherein the storage reservoir is configured to separately collect trichome in at least one of the one or more enclosed compartments.

Another embodiment provides a grinder as described herein-above, wherein the grinder is configured to operably connect to one or more attachment comprising a funnel, a scale, a trichome catch, a joint roller with rolling paper cartridge, and a lighter.

Another embodiment provides a grinder as described herein-above, wherein the storage reservoir or its one or more enclosed compartments is configured to provide one or more airtight environment through one or more O-rings, adhesive material, glue, and tape, located between one or more of adjoining sections of the grinder to the storage reservoir, between multiple compartments of the storage reservoir, and between storage reservoir and its one or more compartments.

Another embodiment provides a grinder as described herein-above, wherein the dispense mechanism comprises one or more dispensing element selected from one or more fan blade, a corkscrew and a plate with cut-out, and an activation means is configured to activate an activation means, and the activation means is selected from a group of movements that activate one or more gears including rotational movement and sliding movement, and a button that activates a motor operably connected to the dispensing element.

Another embodiment provides a grinder as described herein-above, wherein the activation means is configured to start spinning the one or more dispensing element, the spinning movement causing the ground plant material to exit at the bottom point or through a bottom attachment.

Another embodiment provides a grinder as described herein-above, wherein the dispense mechanism configured for manually actuated dispensing.

Another embodiment provides a grinder as described herein-above, wherein the dispense mechanism is configured for electrically actuated dispensing.

Another embodiment provides a grinder as described herein-above, configured with an electrically actuated dispense mechanism that comprises an activation means for activating the dispense mechanism, wherein the activation means is a button operably connected to a motor that when the button is pressed causes the motor to activate the dispense mechanism.

Another embodiment provides a grinder as described herein-above, wherein the dispense mechanism comprises a power supply, wherein the power supply has an output shaft, wherein a fan blade is operably connected to the power supply's output shaft, and wherein the fan blade is configured to spin at suitable RPMs to force the ground plant material above an opening at the bottom point and fall through and out of the opening, and optionally into a plant material consumption device.

Another embodiment provides a grinder as described herein-above, wherein the activation means is a button, and wherein the dispense mechanism is configured to switch to an open configuration upon push of the button which allows it to constantly dispense until the button is released, and upon release of the button to return to a closed configuration.

Another embodiment provides a grinder as described herein-above, wherein in the closed configuration of the dispense mechanism, an opening that exists in the open position is configured to be blocked at one or more location, said location comprising bottom point and fan blade.

Another embodiment provides a grinder as described herein-above, wherein the dispense mechanism is located in a housing that is fitted into one of the storage reservoir and a dedicated dispense tube section of the grinder, and wherein the dispense mechanism comprises operably connected components that include a printed circuit board (PCB), a motor powered through an electric port, and a button to activate the motor.

Another embodiment provides a grinder as described herein-above, wherein the dispense mechanism additionally comprises a hall sensor, a magnet, and a fan blade that are configured to consistently return the fan blade to a closed position upon release of the push button.

Another embodiment provides a grinder as described herein-above, wherein a circuit of the PCB is configured with a notification function that activates if the dispense blade does not cross the hall sensor in a given time, indicating a clog has occurred.

Another embodiment provides a grinder as described herein-above, wherein the grinder is configured to allow the amount of plant material within one or more of top grind cylinder and storage reservoir to be viewed.

Another embodiment provides a grinder as described herein-above, wherein one or more of the top grind cylinder and the storage reservoir is at least partially transparent.

Another embodiment provides a method for grinding, storing and dispensing plant materials that comprises using the grinder of any one of the embodiments of the grinder as described herein-above, or of a combination thereof.

Another embodiment provides the method as described herein-above, wherein grinding is performed manually, and the dispense mechanism is electrically actuated.

Another embodiment provides a method of manufacturing the grinder of any one of the embodiments as described herein-above, or of a combination thereof, that comprises forming substantially cylindrical parts or sections of a modular grinder body, wherein one or more part or section is made of machined metal, and formed from round bar stock by subtractive manufacturing.

### BRIEF DESCRIPTION OF THE DRAWINGS

FIG. 1 is an exploded view of a grinder in a grinding configuration with the parts from top to bottom being top piece 1, that is connected to top grind cylinder 2 (both forming the insert piece), grinder reservoir 3, bottom grind plate 4, storage reservoir 5, that is connected to bottom buffer 6, and bottom point 7, in accordance with certain embodiments of the present invention;

FIG. 2A/B are two exploded views, shown from different viewing angles, of the insert piece showing its parts, i.e. the top piece 1 and the top grind cylinder 2, in accordance with certain embodiments of the present invention;

FIG. 3 is a perspective view of the grinder reservoir 3 in accordance with certain embodiments of the present invention;

FIG. 4 is a section view of the grinder reservoir 3 in accordance with certain embodiments of the present invention;

FIG. 5 is a perspective view of the bottom grind plate 4 in accordance with certain embodiments of the present invention;

FIG. 6 is a perspective view of the bottom grind plate 4 in accordance with certain embodiments of the present invention;

FIG. 7 is a section view of the bottom grind plate 4 in accordance with certain embodiments of the present invention;

FIG. 8 is a perspective view of the insert piece, i.e. top piece 1 connected to top grind cylinder 2, in accordance with certain embodiments of the present invention;

FIG. 9 is perspective view of a grinder in a pre-grinding configuration with funnel 8 connected to grinder reservoir 3, that is connected to bottom grind plate 4, that is connected to storage reservoir 5, that is connected to bottom buffer 6, that is connected to bottom point 7, in accordance with certain embodiments of the present invention;

FIG. 10 is a perspective view of a grinder in a grinding or in a storage configuration (in case of the storage configuration: without top grind cylinder 2), showing the top of top piece 1 above the grinder reservoir 3, that is connected to bottom grind plate 4, that is connected to storage reservoir 5, that is connected to bottom buffer 6, that is connected to the bottom point 7, in accordance with certain embodiments of the present invention;

FIG. 11 is a perspective view of the storage reservoir 5 with button 9 to activate the internal dispense mechanism, and with hole 10 for the sidepiece (e.g. for USB connection or charging), in accordance with certain embodiments of the present invention;

FIG. 12 is an exploded view of the storage reservoir 5 with button 9 and hole 10 for the side piece, and its internal dispense mechanism shown below, comprising the internal part of the side piece 11, circuit board 12, circuit housing 13, and fan blade 14, in accordance with certain embodiments of the present invention;

FIG. 13 A-C show perspective views and FIG. 13D shows a section view of the bottom point 7, in accordance with certain embodiments of the present invention.

The above figures are intended for overview, and do not show all threads/connections of the grinder parts, or their various alternatives, that are described in the detailed specification.

### DETAILED SPECIFICATION

The present invention generally relates to a modular grinder apparatus, methods for manufacture of its modular parts, and methods for grinding, storing, and dispensing dried plant materials using some or all parts of the grinder.

Dried plant materials may include dried herbs, spices, flowers, seeds, and leaves, such as cannabis, coffee, tea, and tobacco, optionally mixed or blended, and optionally pre-ground.

Each part of the grinder is configured to be connected to one or more other part thereof and is configured for assembly into multiple main configurations, including pre-grinding configurations (with funnel attached), grinding configurations (with sections that have grinding teeth), and storage configurations (that exclude one or more sections, e.g. those with grinding teeth, but comprise the storage reservoir and optionally additional reservoirs, or a re-purposed grinding reservoir). Each configuration may be further modified with optional attachments to, or modifications of, the bottom point. The bottom point may also be replaced with a bottom attachment, and multiple bottom attachments and/or bottom points may be provided for different purposes.

Generally the grinder will include a top piece, one or more middle sections, and a bottom point or bottom attachment. These parts are configured to be flexibly assembled into multiple configurations.

The middle sections will generally include the following, typically arranged top to bottom between the top piece and the bottom point in the grinding configuration:
top grind cylinder (with top grind teeth),
grinder reservoir,
bottom grind plate (with bottom grind teeth),
storage reservoir with dispense mechanism
(or optional dedicated dispense tube connected to the bottom of the storage reservoir), and
optional bottom buffer.

Attachments may be configured to attach to or replace any part or section, in particular the bottom point and top piece (in which case they may be referred to as bottom attachment or top attachment); attachments may include a scale to weigh plant material before and/or after grinding (optionally with a digital display that shows the stored amount/weight), a funnel, and consumption attachments that dispensing the ground plant material in a form suitable for consumption, e.g. packaging the ground plant material into a tea bag, coffee sachet, or rolling it into a joint, and in case of the joint, optionally lighting it. The plant material may be fractioned upon grinding, depending on the configuration of the top and bottom grinding teeth/top grind cylinder and/or bottom grind plate, and may separate e.g. the trichome from cannabis leaves, which may be separately stored and/or dispensed, or dispensed together with the remainder of the fractioned leaves, or with together with un-fractioned ground cannabis leaves. Useful attachments include a trichome catch that stores a separated (or enriched) trichome fraction, a trichome dispenser that dispenses trichome, or blends trichome with another fraction (or with un-fractioned plant material), optionally in form of a joint of ground plant material rolled into paper. Useful attachments may thus include a scale, funnel, tea bag filler, coffee sachet filler, trichome catch, joint roller, rolling paper cartridge, and lighter.

Parts, sections and attachments of the grinder may be manually connected, e.g. by being screwed together or taken apart manually; for example, attachments may be added at any part of the grinding process.

The parts and sections of the grinder as described herein are generally cylindrical and of a substantially same or similar outer diameter, but some may have different outer diameters to allow them to slide into each other in one of the configurations, especially the grinding configuration. Typically, the grinder parts detailed above assemble into a substantially pen-like shape of portable size that is suitable for travel.

Usually the outer diameter of the parts will be chosen in a way that allows assembly into a grinder with sleek outer surface and minimized protrusions at least in the storage configuration, and preferably also in the grinding configuration. Thus most parts, and in particular adjacent/neighboring parts, will have the same or similar outer diameter, with exception of an optional funnel at the top, and optional consumption attachments that typically connect at the bottom. If so desired, a middle section, for example, the storage reservoir, may be configured with a grip for holding the grinder. While the bottom point at the bottom of the generally pen-shaped grinder may grow thinner towards the bottom, the top piece and middle sections will generally have the same or similar outer diameter, in particular where the individual parts are connected. Further, while of generally similar diameter, where parts are inserted into each other in one of the configurations, the insert will have a smaller outer diameter than the inner diameter of the part/section it is inserted into, to allow it to fit. This applies in particular to the sections that carry the top and bottom grinding teeth, as e.g. the top grinding teeth may be configured in an insert section, such as the top grind cylinder that may be configured to insert into the grinder reservoir.

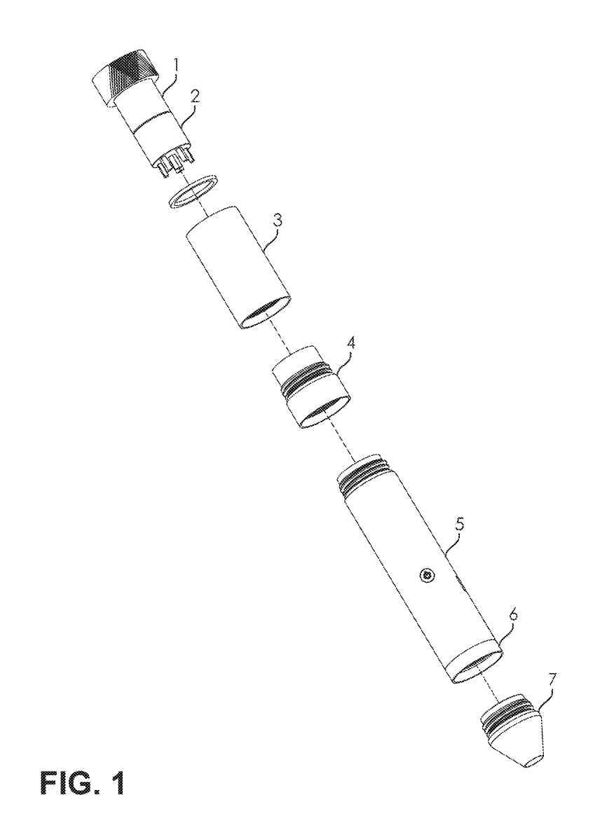

For example, in a grinding configuration (see FIG. 1), the top grind cylinder with top grind teeth connects to the top piece (see FIG. 4) which provides a hand grip to the insert, and allows to push and rotate the resulting connected piece (insert piece) inside the grinder reservoir which at its bottom end is connected to the bottom grind pate that holds the bottom grind teeth (see FIG. 5). Thus the outer diameter of the top grind cylinder and part of the top piece that is inserted, if any, will be configured to be less than the inner diameter of the grinder reservoir. The connections between parts may be achieved e.g. by threads, as explained herein-below, that may be configured to allow the top grind cylinder to still spin within the grinder reservoir when fully connected (e.g. screwed in all the way). For example, the connections may be configured with a threaded part and an unthreaded part, and the unthreaded part will allow spinning.

Optionally, the grinder may also include a funnel that connects to the top grind cylinder (and optionally also connects to the storage reservoir), and one or more optional attachment that connects to the bottom point, or alternatively one or more bottom attachment that replaces the bottom point (e.g. with a joint roller, tea bag filler etc.).

In storage configurations, one or more of top grind teeth and bottom grind teeth may be removed so that upon assembly of the grinder without grind teeth, added storage space is created in the section or sections that the grind teeth are located in, and the grinder in this configuration may be smaller and lighter.

A list of illustrative non-limiting grinder configurations follows:
a) Pre-grinding configuration wherein the top piece and the top grind cylinder are not connected to the remaining mid sections, and instead the funnel is attached to the grinder reservoir, the grinder reservoir is optionally connected to the storage reservoir, the storage reservoir comprises the dispense mechanism, and the storage reservoir is connected to the bottom point that allows ground plant material to exit upon activation of the dispense mechanism;
b) Grinding configuration A, wherein the top piece is connected to the top grind cylinder having grind teeth and connected to the grinder reservoir in which the top piece with top grind cylinder can manually be rotated or spun to grind plant material inserted into the grinder reservoir, the grinder reservoir is connected to the storage reservoir, the storage reservoir comprises the dispense mechanism, and the storage reservoir is connected to the bottom point that allows ground plant material to exit upon activation of the dispense mechanism;
c) Grinding configuration B which is as described for A, but with an attachment to the bottom point.
d) Grinding configuration C which is as described for A, but with the bottom point replaced with an attachment.
e) Storage configuration A, wherein the top grind cylinder is removed and the top piece connects to and closes the grinder reservoir, the grinder reservoir is connected to the storage reservoir, the storage reservoir comprises the dispense mechanism, and the storage reservoir is connected to a bottom point that allows ground plant material to exit upon activation of the dispense mechanism.
f) Storage configuration B, which is as described for A, but without the grinder reservoir, and with the top piece connected to the storage reservoir,
g) Storage configuration C which is as described for A, but with the grinder reservoir replaced by one or more designated additional storage reservoir.

In further variations of the above grinder configurations a-g), the dispense mechanism may not be located in the storage reservoir, but may instead be comprised in a designated dispense tube/section, and the designated dispense tube may be configured to connect to the storage reservoir with its top connection and to the bottom point with its bottom connection. It will be apparent to a person skilled in the art how to modify configurations based on the embodiments and various examples described herein.

A bottom buffer may provide a cushion between the storage reservoir and the bottom point, and may also serve/be configured as a circuit housing cap or plate that closes the bottom of the circuit housing.

The bottom buffer in form of a circuit housing plate closes the bottom part of the circuit housing, keeping ground plant material out, but leaving open a passage through the storage reservoir where ground plant material can pass through to the bottom point, and providing space below inside the storage reservoir, for ground plant material to accumulate before it is moved into the bottom point by the dispense mechanism.

Alternatively, see FIG. 1, the bottom buffer may be configured as an optional designated bottom buffer section located between storage reservoir and bottom point. The designated bottom buffer section together with the bottom part of the circuit housing (the bottom end of which may then be located lower in the storage reservoir, closer to the very bottom) may provide a cushion or buffer for the ground plant material to accumulate before being dispensed at the bottom point, see FIG. 1.

In both alternatives, the bottom plate of the circuit housing may be an integrated part of the circuit housing (e.g. where the housing is manufactured as one part), or may be a separate part configured to connect to the bottom of the circuit housing and close its bottom end.

The following parts or sections are typically configured as follows:

The top piece may be configured as hand grip for manual grinding, to move and/or rotate the section with the top grinding teeth in a grinding configuration, and may be configured as a closing cap to secure ground plant material inside one or more of storage section, grinding cylinder, and optional additional storage section(s) in a storage configuration. In pre-grinding configurations, the top piece may be exchanged e.g. for a funnel to supply dried plant material to the grinding reservoir without spillage. Alternatively the top piece may be configured as or connected to a motor to spin the top grinding teeth. If the top piece is motorized, then a second top piece may be configured as a closing cap. Still alternatively, the top piece may remain stationary and the bottom grind plate may be spun, either manually, or by a motor. In case of motorized bottom grind teeth, the section configured with bottom grind teeth may also be configured with a motor, or an adjacent section may be configured with a motor.

The bottom point is configured to provide an opening for ground plant material to exit, and may optionally be configured to provide a lock to block and secure the opening when the plant ground material is not being dispensed, e.g. in storage configuration, and especially during transport. Optionally, the bottom point may be connected to an attachment, or alternatively may be replaced with a bottom attachment, to provide additional functionality, in particular for packaging into particular forms of consumption (such as tea bag filler, joint roller, etc.).

The middle sections in a grinding configuration include a set of grinding teeth, i.e. top and bottom grinding teeth that interact to grind when pushed together to intersect when pushed and/or rotated, in particular, upon insertion of one section into the other. For example, a grinder may comprise a top grind teeth section and a bottom grind teeth section, and each of the sections may be configured with threads that mate. The threads optionally may be configured with a non-threaded part so that when fully mated one section, here with top grinding teeth (the insert or an insert piece) can spin inside the other section, e.g. here with the bottom grinding teeth, such as a bottom grind plate.

The top grinding teeth section may take the shape of a top grind cylinder as shown in FIGS. 1, 4 and 5, that may be connected to the bottom grinding teeth section which may take the form of a connected piece of the grinder reservoir connected to the bottom grind plate. For example, where the threads of top grind cylinder and grinder reservoir mate, a comparatively flat bottom grind plate with substantially flat rim may fit in between these sections and be secured by them, and thus connect to both of them without need for its own top and bottom mating thread. Alternatively, the bottom grind plate may be its own designated section as shown in e.g. FIGS. 1 and 6.

The grinder may be configured with multiple different sets of grinding teeth that can be exchanged and provide alternative grinding configurations for different plant materials, and/or to achieve a particular desired particle size depending on plant material and preference, and multiple exchangeable grind teeth may be provided for different grinding purposes. The whole set may be exchanged, only the top grind cylinder, or only the bottom grind plate. Alternatively the top grind cylinder may be configured with a top grind plate and both top and bottom plates may be configured to be exchanged, either individually or in sets or pairs.

In particular, a bottom grind plate may be configured to allow ground plant material to fall through the bottom grind plate and into the storage reservoir only when the plant material has been ground to particles small enough. The bottom grind plate may be configured to achieve a particular desired particle size depending on plant material and preference, and multiple exchangeable bottom grind plates may be provided for different grinding purposes.

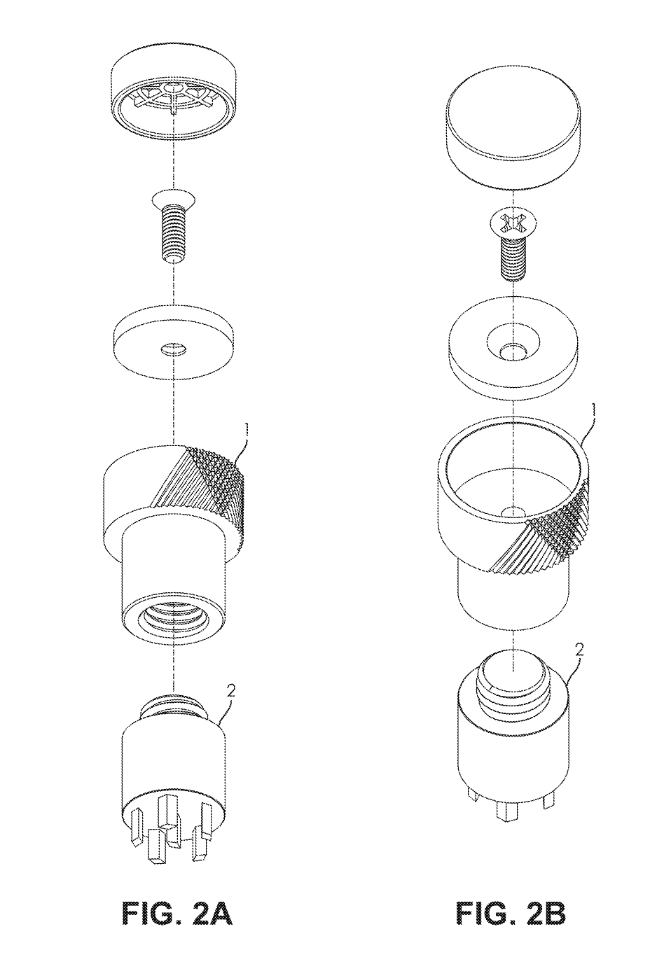

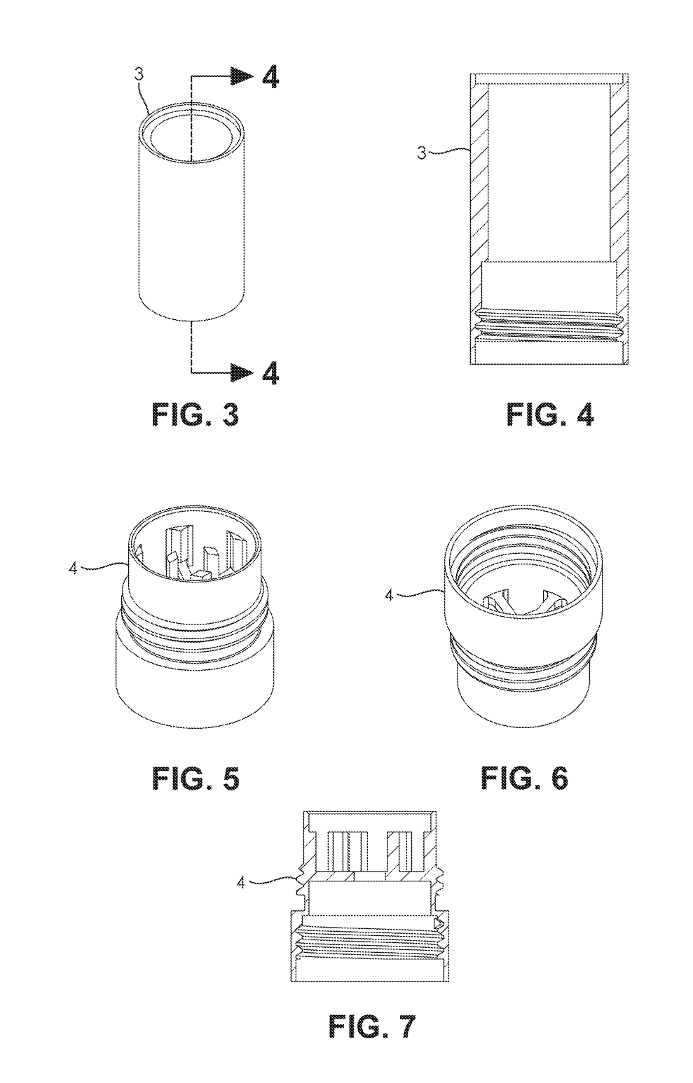

In a storage configuration one or more of top and bottom grind teeth (and/or their corresponding sections), may be removed to increase the grinder's portability in situations when its grinding function is not desired. For example, the top grind cylinder with top grind teeth may be removed, as shown in FIG. 2. Optionally, the grinder reservoir with bottom grind teeth/plate may be taken out, or the grinder reservoir may stay, and just the bottom grind plate may be removed. While the grinder reservoir may accepts and holds the plant material for grinding in the grinding configuration, in a particular storage configuration it may be connected to the storage reservoir and in this configuration may provide spillage-proof storage for additional (pre-) ground plant material, in addition to material inside the storage reservoir. The top connection of the grinder reservoir may then connect to the top piece that then serves as a closing cap and prevents spillage, e.g. during transport.

The grinder may be configured with multiple additional reservoirs for additional storage, e.g. for multiple batches of grinding, and in case of different material in the batches, for their separate storage. For example, when grinding different plant materials, they can be stored in different containers of the grinder (e.g. sections, or part of a section), similarly the need for separate storage may arise when grinding the same material to a different particle size, or when separating the same plant material into different fractions (e.g. when grinding cannabis leaves, separating trichome). In a storage configuration, these one or more additional reservoirs may be added to the grinder as additional sections, or may replace the grinder reservoir and/or the storage reservoir, or may be configured as separate compartments of the storage reservoir, and operably connected to a dispense mechanism and/or attachment.

The storage area (including storage reservoir, grinding reservoir, additional reservoirs) may be transparent or partially transparent or contain a transparent window/cutout, allowing the amount of ground and/or stored plant material to be viewed.

The flexible multiple configurations that the grinder may be assembled into may be achieved by configuring selected grinder parts with matching reversible connections. Reversible connections may be formed by one or more of threads, e.g. screw- or spiral-threads, magnetic parts and magnets. The reversible connections allow a grinder part to reversibly mate to one or more corresponding part (i.e. to each of its neighbor or neighbors in each of its configurations). In case of screw or spiral threads, connecting or disconnecting is achieved by turning/rotating the relevant parts in opposite direction around what will become the main longitudinal axis of the pen-shaped grinder once assembled, i.e. to screw the sections together, or for disassembly, screw them apart. Alternatively, other threads or reversible connections may be used and may or may not assemble by rotation, and may be straight or tapered, and may or may not be friction based, and may or may not be magnetic, and may assemble with or without thread sealant. For example, friction-based connections of flexible materials like certain plastics may require aligning and pushing two neighboring parts together until they “click in” to assemble, and may be simply pulled apart to disassemble. Alternatively, a hook may be provided that clicks into place upon assembly, and disengages either upon pulling/pushing or other mechanical manipulation to disengage, allowing the parts to be separated. In case of magnetic connections, a part or section (e.g. the top piece, or the funnel) may be magnetic, or be configured with a magnet, so that it attaches by magnetic force to one or more part or section made of metal, or to one or more section provided with a matching magnet. For example, matching magnet rings may be embedded into multiple sections that are neighboring sections/parts in one or more configuration of the modular assembly (such as joining the grind plate to the storage reservoir and/or to the grinder reservoir). In another example, the top piece is magnetic or configured with a magnet to magnetically connect to the top grind cylinder, to the grinder reservoir, or to the storage reservoir, depending on the configuration. These sections may connect to the magnetic top piece or to another section by virtue of their material (if they are manufactured from metal), or by virtue of being configured with a matching magnet, e.g. magnetic rings embedded, or otherwise permanently attached (adhesive, friction-based attachment, screws, bolts, nails etc.). Magnets typically are attached at or near the top and/or bottom connection of a part/section, in close enough proximity to the top or bottom connection to provide a stable connection between each pair of neighboring parts/sections upon assembly of each configuration. The location is chosen depending on the magnetic force created between neighboring sections/parts in each magnetic pairing in each configuration.

On one more type of connection may be used to connect the herb grinder modules, e.g. part of the connections may be by threads, and others may be magnetic. For example, sections like the grinder reservoir, bottom grind plate, storage reservoir, bottom buffer and bottom point may be threaded, but the top piece, funnel, and bottom attachments may connect magnetically.

The parts or sections may directly connect, or may connect through an additional connecting piece, e.g. a threaded ring-shaped connector piece that accepts one section or part at each of its ends.

Generally the grinder parts connect near their top and/or bottom end, i.e. have one or more top connection, and one or more bottom connection, and may have internal and external connections, e.g. threads.

A middle section generally has at least one top and at least one bottom connection in at least one configuration, but may have multiple top, or multiple bottom connections to one or more neighboring section in each direction (top/bottom). Thus, these multiple connections may be alternative ones in different configurations, or parallel/simultaneous ones in a particular grinder configuration. For example, the bottom connection of the top piece may be configured to reversibly connect through threads to both the top grind cylinder and to the grinder reservoir in parallel. In another example, a connected piece may be assembled from the grinder reservoir and the bottom grind plate using the grinder reservoir's bottom connection, and in parallel, the same bottom connection of the top grind plate may connect to the top of the storage reservoir, i.e. the connected piece may then be connected to the storage reservoir. Alternatively, the bottom grind plate may be configured to be inserted in the connection between the two other parts, or optionally provide part of the structure of the top or bottom connection. In either of these options, the bottom grind plate (or corresponding middle section) may be easily removed to provide alternative grinder configurations.

Typically a middle section may connect its top connection to another part's bottom connection, and its bottom connection to another part's top connection. However, as many sections may be substantially configured as hollow cylinders and may partially or fully insert into each other, this will not be the case for each connection. For example, an insert section may connect bottom-to-bottom or top-to-top, e.g. by mating its external thread to the internal thread of a cylindrical section it is inserted into.

To allow an insert section (e.g. a section with top grinding teeth such as the top grind cylinder), to still spin within the section it is inserted into (e.g. the grinder reservoir) when its connection is fully mated, the connection can be configured with a no or low friction part that allows spinning, e.g. a thread such as a spiral thread may comprise an unthreaded part that is reached once rotated several times and thus fully connected, to allow the insert piece to spin freely.

In some grinder variants it may be desirable to sacrifice some flexibility in favor of a more straightforward assembly and configure some of the connections between parts incompatible with each other to aid correct and/or prevent incorrect assembly. Furthermore, some parts may be connected irreversibly. Irreversible connections the term is used herein may include permanent connections that cannot be taken apart again without damaging the connection or grinder parts, and connections that require the help of tools to reverse, i.e. that cannot be taken apart manually with unassisted typical effort. For such irreversible connections, more permanent connecting means may be used, such as flange joints, bolts, straight threads or tapered threads that wedge together when engaged, threads or joints with adhesive, or any combination thereof that increases friction and/or the necessary effort of disassembly. Connections prevented by incompatible threads (e.g. different size of diameter, steepness of the spiral, spacings or similar) may be, for example, connections of the top piece to the optional designated dispense tube, and/or to the bottom point. Similarly, threads may occur in different compatibility groups, such that only connections resulting in desired configurations may be achieved. For example, the bottom connection of the storage reservoir and/or the optional designated dispense tube, the bottom point, and optional attachments could form one compatibility group, while the remaining sections could form one or more other compatibility group.

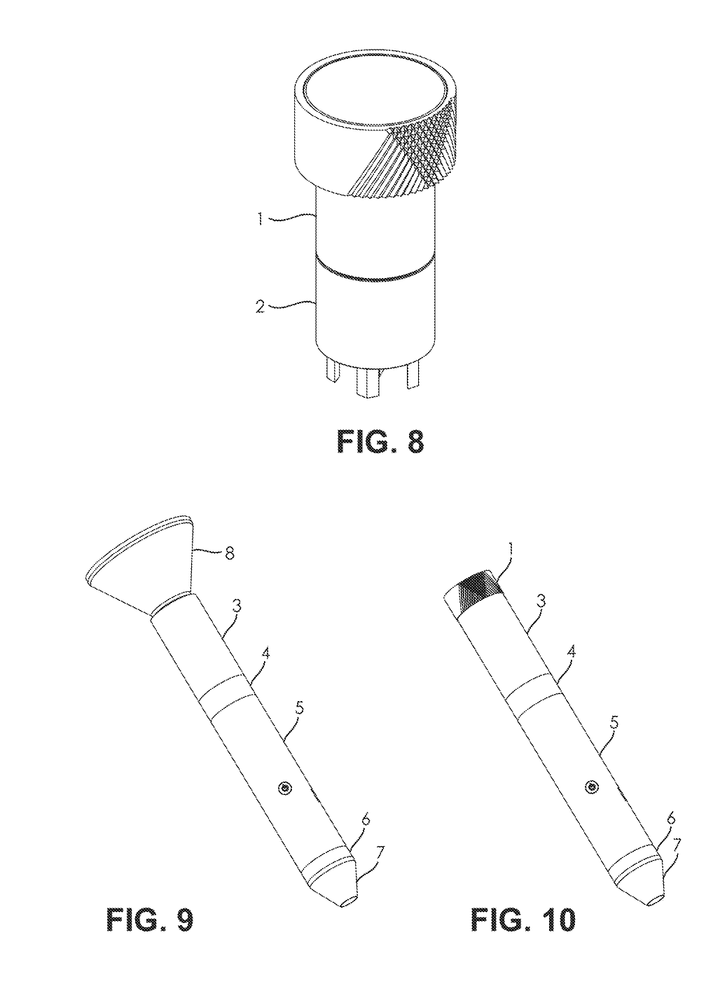

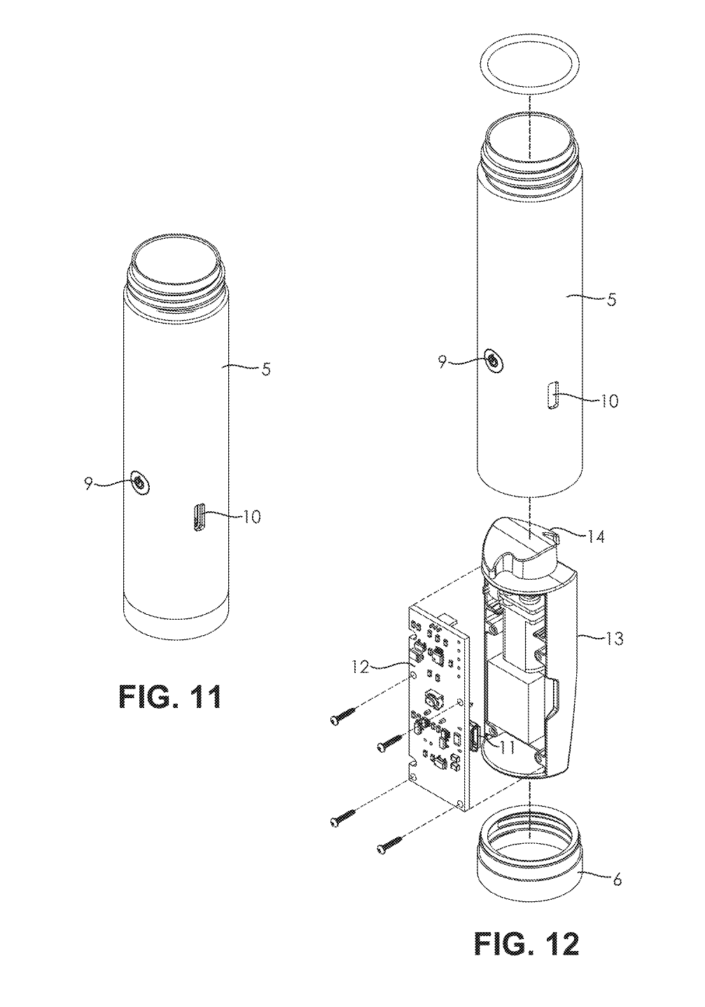

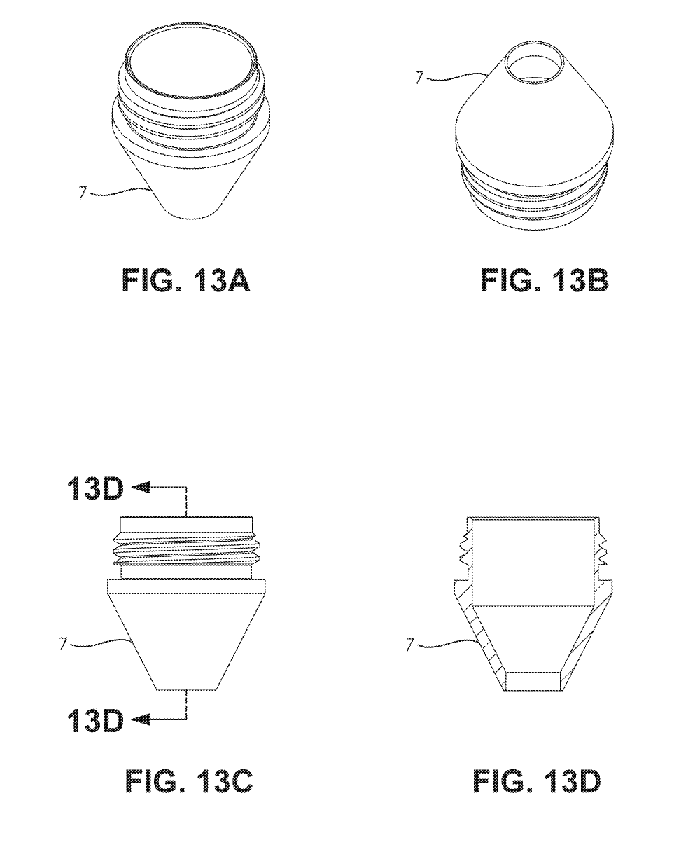

The dispense mechanism may be located in part of the storage reservoir as shown in FIGS. 1, 7 and 8, it may be located in the bottom point, or it may be located in its own designated dispense tube/section. For example, the dispense mechanism may be inserted into the bottom of storage reservoir and may be held in place by friction, e.g. using a press fit and/or a setscrew. The dispense mechanism is operably connected to an activation means such as a button.

A variety of activation means may be useful to activate the dispense mechanism, as will be apparent to a person skilled in the art. The activation means may be configured for manual or electrical activation, depending on the type of dispense mechanism. In case of a manual dispense mechanism, an activation motion (e.g. a rotational/twisting motion or sliding motion) may activate one or more gears operably connected to a dispense element that is caused to rotate and thus dispense the ground plant material. Electrical activation means include any means whose configuration may change from one state into another second state, one of which is configured to activate the dispense mechanism and e.g. move the dispense element (e.g. fan blades), and the other is configured to turn the dispense mechanism off, e.g. so that the fan blades stop, preferably in a particular closed position to stop dispensing any remaining ground plant material and prevent spillage. An on/off button may be used and may generally lie flat against the pen-shaped sleek design, to increase portability of the grinder device. Alternative activation means will be apparent to a person skilled in the art, and may include on/off switches and on/off sensors such as motion or voice sensors (to activate by a certain hand motion or sound signal).

For example, a button that is operably connected to the dispense mechanism may emerge from the side of the storage reservoir, and may be configured to activate the dispense mechanism when pushed. During manufacture, the button and/or its adapter may be pushed into the storage reservoir and held in place by friction, e.g. in form of a press fit. Alternatively, the activation means or button/adapter may be soldered onto the printed circuit board (PCB) that is securely attached to (e.g. screwed onto) the circuit container or housing, which may be held in place by friction, e.g. it may be press fit into the storage reservoir.

The dispensing element includes one or more blades, a corkscrew, and a plate with a cut-out. The dispensing element is rotated upon manual or electrical activation by a suitable activation means or motion.

The dispensing element may be a circular plate with a cut-out (e.g. a “pie piece” shaped triangular hole, or a round hole in the plate) that upon its rotation into a dispensing location releases ground plant material into a passage located below the dispensing location that the cut-out is rotated into. To move plant material more effectively than by force of gravity and friction on the rotating plate surface, the plate may be configured with elements that loosen and move the potentially compacted plant material around in the storage reservoir before the plate arrives in the dispensing location. These elements may be pegs that stick out above the plate surface in essentially perpendicular direction, or angled pegs, or partial walls on the plate's surface that can be perpendicular or angled, or any other element that rises above the plate surface and upon rotation of the plate will be likewise rotated with it, thereby through its motion through the ground plant material loosening it. The pegs or walls may reach a height above the plate surface of, for example, a quarter inch to 2 inches.

Alternatively, the dispensing element may be a corkscrew shaped piece that upon its rotation transports ground plant material downwards to be dispensed.

A manual dispense mechanism may comprise one or more gears operably connected to the dispensing element that upon activation by an activating motion rotates the dispense element and thus dispenses the ground plant material. Activating motions that may actuate the one or more gears, or series of gears, include a rotating/twisting motion of the dispense section, and a sliding motion along a longitudinal axis that runs through the middle of each cylindrical sections of the herb grinder when assembled.

An electrical dispense mechanism may be equipped with a circuit containing a DC or AC gear-motor, a fan blade-shaped piece connected to the output shaft, a hall sensor and a rechargeable port and battery. The rechargeable port may be a Universal Serial Bus (USB) port. The dispense mechanism may spin at low RPMs to force ground material over an opening, causing it to fall through, and eventually out the bottom of the pen/bottom point, for example, into a desired plant material consumption device (e.g. tablespoon, tobacco pipe, vaporizer, tea bag, coffee filter or sachet), or consumption attachment. The dispense mechanism may be powered by a magnetic induction circuit, which may include a magnet and coil.

The dispense mechanism may be configured for constant dispensing upon engaging an activation means, for example, the push of a button. A gear motor may constantly turn inside the dispense mechanism until the activation means, e.g. button, is released, at which point the opening at the bottom point/hole in the pen tip may automatically return to its closed position, eliminating the possibility of spills or leaks. Alternatively, a gear motor may constantly turn inside the dispense mechanism until the activation means, e.g. button, is released, at which point the fan blade may return to the closed position blocking off an opening of the dispense mechanism, to prevent spills.

The fan blade of the dispense mechanism may comprise a single blade, or multiple blades, for example, 2, 3, 4, 5, 6, 7, 8, 9, 10 or more blades.

The dispense mechanism may include a compact configuration of a printed circuit board (PCB), motor, activation means/push button, and USB or micro USB port located in a housing that may easily be friction fit/press fit into place inside the dispense tube, storage reservoir or bottom point. Alternative ways of securely attaching the dispense mechanism include screws, bolts, hooks, adhesive and more, as will be apparent to the skilled person. A hall sensor and a magnet may be used in conjunction with a dispense blade, to consistently return it to the same position when de-energized. Alternatively, a clog notification function in the circuit may notify users about a clog if the dispense blade does not cross the hall sensor in a given time. A clog may develop depending on various factors including the plant material and its residual moisture or lipid components, grind teeth configuration, motor configuration and speed of fan blades. Occasionally, ground plant material may start to get clogged in the dispense mechanism so that the fan blade moves more slowly, or not at all. The PCB may be configured to provide a notification for an operator of the grinder. There may or may not be need for a magnet in the middle section of the grinder, to help with/prevent clogging.

The grinder, in particular its dispense mechanism or its attachments, may be configured to be operated while charging.

Converting the grinder from one of its storage configurations into one of its grinding configurations may involve removing (e.g. screwing off) the top piece to open up the top of the grinder reservoir, inserting plant material (e.g. whole or ground herbs or spices) into the grinder reservoir, connecting the top piece and the top grind cylinder, inserting the connected piece of top piece and top grind cylinder (the insert piece) into the grinder reservoir, pushing the insert piece down and connecting/screwing it into the grinder reservoir, e.g. connecting it through threads configured to allow the insert piece to spin freely inside grinder reservoir when being fully connected to the grinder reservoir (e.g. when using spiral threads: when screwed all the way in), collecting and storing the ground plant material in the storage reservoir until the dispense mechanism is activated, and optionally activating the dispense mechanism to move the ground plant material from the storage reservoir to the bottom point to be ejected/dispensed from its opening at the bottom. The dispense mechanism may be activated, for example, by pressing a button, e.g. a button that passes through the side of the storage reservoir.

The grinder may be manufactured using a variety of processes and materials such as: 3D printed metal, molded metal, machined metal, machined plastic, subtractive manufacturing, plastic injection molding, 3D printed plastic, ceramics, molded plastic, and/or crafted wood.

A skilled artisan will readily appreciate that the techniques and methods described herein may be performed using various machining techniques and systems. Similarly, the products formed by the techniques and methods described herein may be formed using various machining techniques and materials. Machining is any of various processes in which a piece of raw material is cut into a desired final shape and size by a controlled material-removal process. The processes that have this common theme, controlled material removal, today are collectively known as subtractive manufacturing, in distinction from processes of controlled material addition, which are known as additive manufacturing. The controlled removal process may comprise the use of machine tools, power tools, and/or hand tools. The removal process may comprise cutting, boring, grinding, shearing, or other forms of deformation. While machining is a part of the manufacture of many metal products, it can also be used on materials such as wood, plastic, ceramic, and composites.

A skilled artisan will readily appreciate that the techniques and methods described herein may be performed using various injection molding techniques and systems. Similarly, the products formed by the techniques and methods described herein may be formed using various injection molding techniques and materials. Injection molding is a manufacturing process for producing parts by injecting material into a mold. Injection molding can be performed with a host of materials, including metals (for which the process is called die-casting), glasses, elastomers, confections, and most commonly thermoplastic and thermosetting polymers. Material for the part is fed into a heated barrel, mixed, and forced into a mold cavity, where it cools and hardens to the configuration of the cavity.

A skilled artisan will readily appreciate that the techniques and methods described herein may be performed using various additive manufacturing and/or three-dimensional (3D) printing systems. Similarly, the products formed by the techniques and methods described herein may be formed using various additive manufacturing and/or 3D printing systems and materials. Typically, additive manufacturing or 3D printing techniques start from a digital representation of the 3D object to be formed. Generally, the digital representation is divided into a series of cross-sectional layers, which are overlaid to form the object as a whole. The layers represent the 3D object, and may be generated using additive manufacturing modeling software executed by a computing device. For example, the software may include computer aided design and manufacturing (CAD/CAM) software. Information about the cross-sectional layers of the 3D object may be stored as cross-sectional data. An additive manufacturing or 3D printing machine or system utilizes the cross-sectional data for the purpose of building the 3D object on a layer-by-layer basis. Accordingly, additive manufacturing or 3D printing allows for fabrication of 3D objects directly from computer generated data of the objects, such as computer aided design (CAD) files. Additive manufacturing or 3D printing provides the ability to quickly manufacture both simple and complex parts without tooling and without the need for assembly of different parts.

Any combination of injection molding, machining, and additive manufacturing techniques may be used in the embodiments of the present invention to manufacture the parts of the grinder.

Due to the flexible nature of assembling the modular parts and sections of the grinder, many different configurations are possible, as will be apparent to a person skilled in the art from the numerous variants, options and examples described herein. For sake of brevity, not every single variation of the described parts, sections, features or configurations is discussed herein in explicit detail. However, without departing from the present invention, each part, section, feature or configuration of the grinder may be combined fully or partially with other parts, sections, features or configurations mentioned in respect of different embodiments presented herein to result in a functional embodiment that is capable of modular assembly and in at least one of its configurations will grind, store and dispense dried plant material, as will be apparent to the skilled person.

Various aspects of the grinder, its manufacture and use are described herein with reference to specific forms, configurations and embodiments selected for the purpose of illustration, and should not be construed to limit the invention. Similarly, the figures provided herein are not drawn to any particular proportion or scale, are illustrative only, and many variations may be made to the grinder and its configurations as described herein, including the following illustrative embodiments.

In a particular embodiment of the grinder, internal threads of the top piece may be configured to connect to the external threads of the top grind cylinder, and the external threads of the top piece may be configured to connect to internal threads of the grinder reservoir whether or not the grind cylinder is connected to the top piece.

In another embodiment of the grinder, the top grind cylinder may be configured to connect to another section of the grinder, including a funnel configured to connect to a top connection of the grind cylinder, and the storage reservoir may be configured to connect to a bottom connection of the grind cylinder.

In another embodiment of the grinder, the top piece may connect to both the top grind cylinder and the grinder reservoir through threads. The top piece may connect to the top grind cylinder through internal threading, where the external threading of the top grind cylinder screws in. External threads on the top piece may connect to internal threads on the grinder reservoir. The external threads on the top piece may connect to the internal threads of the grinder reservoir whether or not the grind cylinder is connected to the top piece. Top grind cylinder may connect to the top piece or may connect to another part of the herb grinder device in other embodiments. The top grind cylinder may connect by external threading that screws into internal threading in the top piece.

In another embodiment of the grinder, the grinder reservoir may be configured to connect to the top piece, and may be configured to connect to both the bottom grind plate and the storage reservoir.

In another embodiment of the grinder, the grinder reservoir may be configured to make the top connection to the top piece with an internal thread that connects to the external thread of the top piece, and the grinder reservoir may be configured to connect to both the bottom grind plate and the storage reservoir.)

In another embodiment of the grinder, the grinder reservoir may be configured to simultaneously connect to the bottom grind plate and to the storage reservoir, i.e. in one configuration.

In another embodiment of the grinder, the grinder reservoir may be configured to connect to one of bottom grind plate or storage reservoir at a time, i.e. in different configurations.

In another embodiment of the grinder, the grinder reservoir may connect with the top piece, and may connect with both bottom grind plate and storage reservoir. The grinder reservoir may make the top connection to the top piece with an internal thread that connects to the external thread of the top piece. The grinder reservoir may connect to the bottom grind plate and the storage reservoir through internal threads that may connect to the external threads that may be on the bottom grind plate and the storage reservoir. The grinder reservoir may be configured to only connect to one of the bottom grind plate or the storage reservoir at a time (in different/alternative configurations), or may be configured to connect to both the bottom grind plate and storage reservoir simultaneously (in a particular configuration).

In another embodiment of the grinder, the bottom grind plate may have an internal and an external thread, and the external thread of the bottom grind plate may be configured to connect to the internal thread of the grinder reservoir, and the internal thread of the bottom grind plate may be configured to connect to the external thread of the storage reservoir.

In another embodiment of the grinder, the storage reservoir may connect to the grinder reservoir or to the bottom grind plate at its top connection, and to the bottom point at its bottom connection. The storage reservoir may also house a dispense mechanism and at its top connection may connect to the grinder reservoir and to the bottom grind plate using external threads that connect to the internal threads of the grinder reservoir and the bottom grind plate. The storage reservoir may be configured to only connect to either the grinder reservoir or the bottom grind plate at a time, or to connect to both the grinder reservoir and the bottom grind plate simultaneously. The storage reservoir may connect at the bottom to the bottom point through a press fit or screw or threads. The bottom point may push up into storage reservoir with the outer wall of the bottom point pushing out against the inner wall of the storage reservoir.

In another embodiment of the grinder, the storage reservoir may have a top connection and a bottom connection, and at its top connection may be configured to connect to one or more of the grinder reservoir and the bottom grind plate, and at its bottom connection may connect to the bottom point.

In another embodiment of the grinder, the storage reservoir, grinder reservoir, and bottom grind plate each may have one or more thread, and the one or more thread may be internal or external, and the external thread or threads of the storage reservoir may be configured to connect to the internal thread of the grinder reservoir and to the internal thread of the bottom grind plate.

In another embodiment of the grinder, the storage reservoir, grinder reservoir, and bottom grind plate each may have one or more threads, and the threads of the storage reservoir may be configured to simultaneously connect to the threads of the grinder reservoir and of the bottom grind plate.

In another embodiment of the grinder, the storage reservoir, grinder reservoir, and bottom grind plate each may have one or more threads, and the threads of the storage reservoir may be configured to connect to only one of the following two threads: the thread of the grinder reservoir, and the thread of the bottom grind plate.

In another embodiment of the grinder, the bottom connection of the storage reservoir to the bottom point may be selected from the group consisting of a press fit, a screw, and threads.

In another embodiment of the grinder, the bottom point and the storage reservoir each may have an inner and an outer wall, and the bottom point may push up into the storage reservoir, and the outer wall of the bottom point may push out into the inner wall of the storage reservoir.

In another embodiment of the grinder, one or more of top grind teeth and bottom grind teeth may be configured removable.

In another embodiment of the grinder, the grinder may be divided into three components: a grinder component, a storage component, and a dispenser component.

In another embodiment of the grinder, one or more of the top grind cylinder or the bottom grind plate may comprise intersecting diamond grind teeth that may be manually spun to break up the plant material into small pieces, and the grind teeth may have a shape selected from the group consisting of circular, cylindrical, oval, rectangular, and trapezoidal.

In another embodiment of the grinder, one or more of the top grind cylinder and the bottom grind plate may be configured to be manually spun to grind the plant material.

In another embodiment of the grinder, one or more of the top grind cylinder and the bottom grind plate may be configured to be spun by a motor to grind the plant material.

In another embodiment of the grinder, the grinder may be divided into three components that comprise the grinder (i.e. one or more sections with grinding teeth), the storage (i.e. storage reservoir and optional additional storage), and the dispenser (located in the storage reservoir or in a dedicated dispense tube/section). The grinder/sections with grinding teeth may use conventional intersecting, circular diamond grind teeth that are manually spun to break up the desired material into small pieces. The shape of the teeth may be cylindrical, oval, rectangular, or trapezoidal.

In another embodiment of the grinder, one or more part of the grinder may be manufactured from one or more of 3D printed metal, molded metal, machined metal, machined plastic, 3D printed plastic, ceramics, molded glass, molded elastomer, molded confections, molded thermoplastic polymer, molded thermosetting polymer, molded plastic, and crafted wood.

In another embodiment of the grinder, one or more part or section of the grinder may be manufactured using one or more of machining, additive manufacturing, 3D printing, subtractive manufacturing, injection molding, die-casting, and plastic injection molding.

In another embodiment of the grinder, the grinder and in particular its grind teeth may be configured to grind dried plant materials selected from the group consisting of cannabis, coffee, tea, and tobacco.

In another embodiment of the grinder, a section of the grinder may be configured as a trichome catch, or to attach to a trichome catch, for example, a bottom section of the grinder, such as the bottom point.

In another embodiment of the grinder, a bottom section of the grinder, e.g. the storage reservoir, a designated dispense tube, or the bottom point, configured with a dispense mechanism, may be operably connected to a joint roller that forms a rolled joint from the ground plant material and from rolling paper which may be supplied from a rolling paper cartridge that a middle section is configured with, and an activation means (e.g. button) of the dispense mechanism may be configured to eject the rolled joint when the joint roller is attached and the activation means is pressed.

In another embodiment of the grinder, the grinder may be configured with a scale operably connected to the grinder to measure and show the weight of the stored plant material.

In another embodiment of the grinder, the dispense mechanism may be activated by a button located in the side of the storage reservoir.

In another embodiment of the grinder, the dispense mechanism may be located in the bottom of the storage reservoir and held in place by one or more fastening means selected from a press fit and a setscrew, and an activation means, e.g. a button, at the side of the storage reservoir may be operably connected to the dispense mechanism to activate it.

In another embodiment of the grinder, the dispense mechanism may comprises a motor that spins one or more fan blade.

In another embodiment of the grinder, the activation means may be a button operably connected to a motor, that when it is pressed causes the motor to spin one or more fan blade of the dispense mechanism.

In another embodiment of the grinder, the dispense mechanism may comprise one or more of operably connected electrical components that form a dispense mechanism circuitry that may comprise one or more of resistor, capacitor, transistor, amplifier, and diode.

In another embodiment of the grinder, a housing inserted into a middle section of the grinder may be configured to house one or more of the motor, the fan blades, the battery, the hall sensor, and the dispense mechanism circuitry in a circuitry housing.

In another embodiment of the grinder, a bottom buffer is configured as a disc or cap, or a section comprising a disc or cap, that closes the bottom of the circuitry housing but allows ground plant material to pass through to be dispensed at the bottom point.

In another embodiment of the grinder, the dispense mechanism may comprise a power supply which has an output shaft, and a fan blade that may be operably connected to the power supply's output shaft, and the fan blade may be configured to spin at suitable RPM to force the ground plant material above an opening at the bottom point and fall through and out of the opening, and optionally into a plant material consumption device, or other attachment.

In another embodiment of the grinder, the grinder may comprise a hall sensor, a battery, and a port configured to provide power to the motor and recharge the battery (rechargeable port), optionally recharging the battery during operation of the power supply.

In another embodiment of the grinder, the power source may be selected from DC gear-motor, AC gear-motor, magnetic induction circuit, and magnet with coil.

In another embodiment of the grinder, the activation means may be a button, and the dispense mechanism may be configured to switch to an open configuration upon push of the button which allows it to constantly dispense until the button is released, and upon release of the button to return to a closed configuration.

In another embodiment of the grinder, the dispense mechanism may comprise a gear motor that constantly turns upon push of the button continuing until the button is released.

In another embodiment of the grinder, in the closed configuration of the dispense mechanism, an opening that exists in the open position may be configured to be blocked at one or more location, said location comprising bottom point and fan blade.

In another embodiment of the grinder, a storage reservoir sidepiece may be configured for operable connection of electrical components of the grinder to a power source, and the electrical connection may comprise a charger, charger cable, USB charger, micro USB charger, USB charger, and micro USB cable. The sidepiece may attach at a hole configured in the storage reservoir for connecting the dispense mechanism circuitry to a power source, see FIG. 12.

In another embodiment of the grinder, a dispense mechanism cover piece that covers an opening in the section that houses the dispense mechanism may be configured to provide an adapter that connects to and secures or houses the button.

In another embodiment of the grinder, a storage reservoir sidepiece may be operably connected to one or more of a circuitry element of the dispense mechanism, and an activations means such as a button. The button may be attached to a cover piece that covers a hole configured in the storage reservoir for connection to the internal dispense mechanism circuitry, and may attach to a button/button cap at the surface of the storage reservoir via an adapter.

Another embodiment provides a method for grinding, storing and dispensing plant material that uses the grinder as described herein, in any of its main, modified or alternative configurations, and with or without attachments.

In another embodiment the method may comprise manually grinding plant material with a pen-shaped grinder configured with intersecting, circular diamond grind teeth in a top grind cylinder section that may be manually spun, storing the resulting ground plant material in an airtight environment in a storage reservoir (or the grinder reservoir, or an additional reservoir) of the grinder until activating a dispense mechanism, and optionally dispensing a quantity of the ground plant material at a bottom point of the grinder, wherein the grinder may comprise a section for grinding and a section for storing that reversibly connect by hand.

In another embodiment the method may comprise manually grinding plant material with intersecting, circular diamond grind teeth at the top of a pen-shaped grinder device, storing plant material in an airtight environment in the middle of said pen-shaped grinder device, and dispensing the ground plant material at the bottom tip/bottom point of the pen-shaped grinder device.

Another embodiment provides a method wherein the top piece may be reversibly connected to the top grind cylinder, and the resulting connected piece may be inserted into and reversibly connected to the grinder reservoir wherein the top piece with top grind cylinder may spin freely in the grinder reservoir around the longitudinal axis of the grinder and the top piece with top grind cylinder may be turned/rotated within the grinder reservoir to grind the plant material between the grind teeth of the top grind cylinder, and the grind teeth of the bottom grind plate which is connected to the bottom of the grinder reservoir.

Another embodiment provides a method wherein grinding is performed manually, and dispensing is electrically actuated by the dispense mechanism.

Another embodiment provides a method wherein the dispense mechanism may be comprised in one of the storage reservoir and an optional dedicated dispense tube section.

In another embodiment the method may comprise manually grinding plant material in the grinder, storing the ground plant material in the storage reservoir of the grinder until the dispense mechanism is activated, activating the dispense mechanism by pressing a button thereby moving ground plant material from the storage reservoir to and through the bottom point to exit out of an opening in the bottom point.

In another embodiment the method may comprise collecting trichome separately from other marihuana plant parts, and separately dispensing ground trichome and ground non-trichome plant material, optionally in an attached trichome catch.

In another embodiment the method may comprise rolling a joint into paper from a paper cartridge of the grinder, and by pressing the button of the dispense mechanism ejecting a rolled joint that optionally is lit by a lighter of the grinder.

Another embodiment provides a method of manufacturing a grinder by forming parts or sections of a modular grinder body, wherein one or more part or section of the grinder may be manufactured by die-casting metal.

Another embodiment of the method of manufacturing may comprise manufacturing one or more part or section and an optional funnel by 3D printing with one or more material, the material comprising metal, plastic, elastomer, ceramics, glass, and polymer.

Another embodiment of the method of manufacturing may comprise injection molding from plastic material of one or more part or section of the grinder, including the optional funnel.

What is claimed is:

1. A grinder to grind, store and dispense plant materials, the plant materials comprising dried herbs, spices, flowers, seeds, and leaves;
wherein the grinder is configured for manual modular assembly of parts that are configured to reversibly connect into multiple configurations that include a grinding configuration and a storage configuration;
wherein the parts comprise a top piece, multiple middle sections, and a bottom point;
wherein the top piece, each middle section, and the bottom point are configured to connect to one or more other section with reversible connections that allow for assembly into the multiple configurations;
wherein the top piece is configured to reversibly connect to one or more middle section, and one or more middle section is configured to connect to the bottom point;
wherein the middle sections comprise a set of grind teeth that separates into top and bottom grind teeth, a grinder reservoir, a storage reservoir, and a dispense mechanism;
wherein the grinding configuration comprises a set of grind teeth, and the storage configuration excludes one or more section having grind teeth, and the excluded one or more section comprises a section with top grind teeth, and a section with bottom grind teeth; and
wherein the top piece is configured to close an opening at the top of the grinder when reversibly connected to the top of one or more of grinder reservoir and storage reservoir in the storage configuration.

2. There grinder of claim 1, wherein the set of grinding teeth comprises a top grind cylinder with teeth at or near its bottom end, and a bottom grind plate;
wherein the top piece is configured to provide a handgrip for manual grinding when reversibly connected to the top of the top grind cylinder in the grinding configuration,
wherein the top grind cylinder is configured to reversibly connect to the bottom of the top piece with its top connection to provide an insert piece;
wherein the insert piece is configured to insert into and reversibly connect to the grinder reservoir with a connection configured to allow it to spin and grind plant material;
wherein the grinder reservoir is configured to reversibly connect to the top piece, to the top grind cylinder, to connect to the bottom grind plate, and optionally to connect the top of the storage reservoir;
wherein the bottom grind plate is configured to connect to the bottom of the grinder reservoir and the top of the storage reservoir, and is configured to allow ground plant material of a desired particle size to fall through from the grinder reservoir to the storage reservoir;
wherein the storage reservoir is configured to connect to one or more of the bottom of the grinder reservoir and the bottom of the bottom grind plate, and to connect to one or more of the top of the bottom point, the top of the optional dedicated dispense tube, and the top of one or more optional attachments;
wherein the dispense mechanism is housed within the storage reservoir, or in an optional dedicated dispenser tube, and is configured to move the ground plant material to the bottom point or to a bottom attachment when the dispense mechanism is activated; and
wherein the bottom point or bottom attachment is configured to reversibly connect with its top connection to the bottom of the storage reservoir or to the bottom of the optional dedicated dispenser tube, and wherein the bottom point or bottom attachment is configured to allow ground plant material to exit from the bottom of the grinder when the dispense mechanism is activated.

3. The grinder of claim 1, wherein each of the multiple parts that reversibly connect to one or more other part is configured with one or more connection, and the one or more connection is configured by one or more of the group consisting of: threads that are configured to mate, magnets that that are configured to connect, a magnet attached to a part of the herb grinder that is configured to connect to another metal part, magnetic material of a part that is configured to connect to one or more of another metal part, another magnet of another part, and another magnetic part.

4. The grinder of claim 3, wherein the top piece is configured to reversibly connect through threads to both the top grind cylinder and to the grinder reservoir;
wherein the grinder reservoir is configured to connect to the top piece, and is configured to connect to one or more of the bottom grind plate and the storage reservoir, either simultaneously or alternatively;
wherein the storage reservoir is configured to connect to one or more of the grinder reservoir and the bottom grind plate, either simultaneously or alternatively; and
wherein the storage reservoir has a top connection and a bottom connection, and at its top connection is configured to connect to one or more of the grinder reservoir and the bottom grind plate, and at its bottom connection connects to the bottom point.

5. The grinder of claim 4, wherein the top piece and the top grind cylinder are configured to be inserted and screwed into the grinder reservoir through their thread connections, and wherein the top piece comprise a non-threaded section that allows the top piece and top grind cylinder to spin freely inside the grinder reservoir when their threads are fully mated to the threads of the grinder reservoir.

6. The grinder of claim 3, wherein the top piece magnetic and connects to both the top grind cylinder and to the grinder reservoir;
wherein the top grind cylinder and the grinder reservoir are metal sections, or are adapted with magnets configured to connect to the top piece;
wherein the grinder reservoir is configured to connect to the top piece magnetically, and is configured to connect to one or more of the bottom grind plate and the storage reservoir, either simultaneously or alternatively;
wherein the storage reservoir is configured to connect to one or more of the grinder reservoir and the bottom grind plate, either simultaneously or alternatively; and
wherein the storage reservoir has a top connection and a bottom connection, and at its top connection is configured to connect to one or more of the grinder reservoir and the bottom grind plate, and at its bottom connection connects to the bottom point.

7. The grinder of claim 1, wherein one or more of its parts and sections are configured to provide an enclosed environment including an airtight environment, a watertight environment, and an airtight and watertight environment.

8. The grinder of claim 7, wherein one or more of its parts and sections are configured to provide a sealed environment upon assembly, with one or more O-rings placed where sections connect.

9. The grinder of claim 2, wherein the teeth of the top grind cylinder comprise intersecting, circular diamond grind teeth.

10. The grinder of claim 2, wherein and the teeth of the top grind cylinder and the bottom grind plate form an intersecting set configured to allow grinding.

11. The grinder of claim 2, wherein the teeth of the top grind cylinder or the bottom grind plate comprise one or more sets of teeth having a shape selected from circular, cylindrical, oval, rectangular, and trapezoidal teeth, or a combination thereof.

12. The grinder of claim 10, wherein the teeth of one or more of top grind cylinder and bottom grind plate comprise a teeth configuration selected from pyramidal, square, circular, oval, curved, pointy, flat, convex, concave, or any combination thereof.

13. The grinder of claim 1, wherein one or more of the sections are adapted from round bar stock by subtractive manufacturing.

14. The grinder of claim 1, wherein the storage reservoir comprises more one or more enclosed compartment to store the ground plant material.

15. The grinder of claim 1, wherein the storage reservoir is configured to separately collect trichome in at least one of the one or more enclosed compartments.

16. The grinder of claim 1, wherein the grinder is configured to operably connect to one or more attachment comprising a funnel, a scale, a trichome catch, a joint roller with rolling paper cartridge, and a lighter.

17. The grinder of claim 1, wherein the storage reservoir or its one or more enclosed compartments is configured to provide one or more airtight environment through one or more O-rings, adhesive material, glue, and tape, located between one or more of adjoining sections of the grinder to the storage reservoir, between multiple compartments of the storage reservoir, and between storage reservoir and its one or more compartments.

18. The grinder of claim 1, wherein the dispense mechanism comprises one or more dispensing element selected from one or more fan blade, a corkscrew and a plate with cut-out, and an activation means is configured to activate an activation means, and the activation means is selected from a group of movements that activate one or more gears including rotational movement and sliding movement, and a button that activates a motor operably connected to the dispensing element.

19. The grinder of claim 18, wherein the activation means is configured to start spinning the one or more dispensing element, the spinning movement causing the ground plant material to exit at the bottom point or through a bottom attachment.

20. The grinder of claim 18, wherein the dispense mechanism configured for manually actuated dispensing.

21. The grinder of claim 18, wherein the dispense mechanism is configured for electrically actuated dispensing.

22. The grinder of claim 18 configured with an electrically actuated dispense mechanism that comprises an activation means for activating the dispense mechanism, wherein the activation means is a button operably connected to a motor that when the button is pressed causes the motor to activate the dispense mechanism.

23. The grinder of claim 1, wherein the dispense mechanism comprises a power supply, wherein the power supply has an output shaft, wherein a fan blade is operably connected to the power supply's output shaft, and wherein the fan blade is configured to spin at suitable RPMs to force the ground plant material above an opening at the bottom point and fall through and out of the opening, and optionally into a plant material consumption device.

24. The grinder of claim 1 wherein the activation means is a button, and wherein the dispense mechanism is configured to switch to an open configuration upon push of the button which allows it to constantly dispense until the button is released, and upon release of the button to return to a closed configuration.

25. The grinder of claim 22, wherein in the closed configuration of the dispense mechanism, an opening that exists in the open position is configured to be blocked at one or more location, said location comprising bottom point and fan blade.

26. The grinder of claim 1, wherein the dispense mechanism is located in a housing that is fitted into one of the storage reservoir and a dedicated dispense tube section of the grinder, and wherein the dispense mechanism comprises operably connected components that include a printed circuit board (PCB), a motor powered through an electric port, and a button to activate the motor.

27. The grinder of claim 24, wherein the dispense mechanism additionally comprises a hall sensor, a magnet, and a fan blade that are configured to consistently return the fan blade to a closed position upon release of the push button.

28. The grinder of claim 24, wherein a circuit of the PCB is configured with a notification function that activates if the dispense blade does not cross the hall sensor in a given time, indicating a clog has occurred.

29. The grinder of claim 1, wherein the grinder is configured to allow the amount of plant material within one or more of top grind cylinder and storage reservoir to be viewed.

30. The grinder of claim 27 wherein one or more of the top grind cylinder and the storage reservoir is at least partially transparent.

31. A method for grinding, storing and dispensing plant materials, using the grinder of claim 1.

32. The method of claim 29, wherein grinding is performed manually, and the dispense mechanism is electrically actuated.

33. A method of manufacturing a grinder that comprises forming substantially cylindrical parts or sections of a modular grinder body, wherein one or more part or section is made of machined metal, and formed from round bar stock by subtractive manufacturing.
